(19) United States
(12) Patent Application Publication
(10) Pub. No.: US 2019/0376817 A1
(43) Pub. Date: Dec. 12, 2019

(54) ENCODER

(71) Applicant: FANUC CORPORATION, Yamanashi (JP)

(72) Inventors: Masao FUKUDA, Yamanashi-ken (JP); Nobuyuki OOTAKE, Yamanashi-ken (JP)

(21) Appl. No.: 16/430,561

(22) Filed: Jun. 4, 2019

(30) Foreign Application Priority Data
Jun. 6, 2018 (JP) 2018-108358

(51) Int. Cl. G01D 5/347

(52) U.S. Cl. CPC G01D 5/3473; G01D 5/34784; G01D 5/34715

(57) ABSTRACT

An encoder includes: a disk having a pattern of slits arranged in one direction; a light emitting element for emitting light toward the pattern of the disk; multiple first light receiving elements for receiving the light emitted from the light emitting element, by way of the slits and outputting a signal according to the amount of the received light; and multiple second light receiving elements for receiving the light emitted from the light emitting element, by way of the slits, at a phase different from a phase at which the first light receiving elements receive the light, and outputting a signal according to an amount of the received light. In this configuration, a first region in which the multiple first light receiving elements are arranged and a second region in which the multiple second light receiving elements are arranged are provided so as to be separated from each other.

### CROSS-REFERENCE TO RELATED APPLICATION

This application is based upon and claims the benefit of priority from Japanese Patent Application No. 2018-108358 filed on Jun. 6, 2018, the contents of which are incorporated herein by reference.

### BACKGROUND OF THE INVENTION

### Field of the Invention

The present invention relates to an optical encoder.

### Description of the Related Art

Japanese Laid-Open Patent Publication No. 2015-090306 discloses an optical encoder having a plurality of light receiving elements for receiving light reflected by slits provided on a disk at a predetermined pitch.

### SUMMARY OF THE INVENTION

In the encoder of the technology disclosed in Japanese Laid-Open Patent Publication No. 2015-090306, the resolution can be increased as the pitch of the slits is narrowed and as the pitch of the light receiving elements is narrowed corresponding to the pitch of the slits. However, in manufacturing of the light receiving elements, the pitch of the light receiving elements needs to be set at a certain distance or greater, which has been a factor of hindering the improvement of resolution.

The present invention has been devised to solve the above problems, it is therefore an object of the present invention is to provide an encoder capable of improving resolution.

According to an aspect of the invention, an encoder includes: a disk configured to have a pattern of slits arranged in one direction; a light emitting element configured to emit light toward the pattern of the disk; a plurality of first light receiving elements configured to receive the light emitted from the light emitting element, by way of the slits and to output a signal according to the amount of the received light; and a plurality of second light receiving elements configured to receive the light emitted from the light emitting element, by way of the slits, at a phase different from a phase at which the first light receiving elements receive the light, and to output a signal according to an amount of the received light; wherein a first region in which the plurality of first light receiving elements are arranged and a second region in which the plurality of second light receiving elements are arranged are provided so as to be separated from each other.

According to the present invention, it is possible to improve the resolution of the encoder.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view of an encoder;

FIG. 2 is a schematic view of a disk as viewed from the rotational axis direction;

FIG. 3 is an enlarged schematic view of a pattern of a disk;

FIG. 4 is a schematic view of an optical unit;

FIG. 5 is a schematic view of light receiving elements;

FIG. 6 is a schematic view of an optical unit;

FIG. 7 is a schematic view of an optical unit;

FIG. 8 is a schematic view of an optical unit;

FIG. 9 is a schematic view of an optical unit;

FIG. 10 is a schematic view of an optical unit;

FIG. 11 is a schematic view of an optical unit; and

FIG. 12 is a schematic view of an encoder.

### DESCRIPTION OF THE PREFERRED EMBODIMENTS

### First Embodiment

### Overview of Encoder

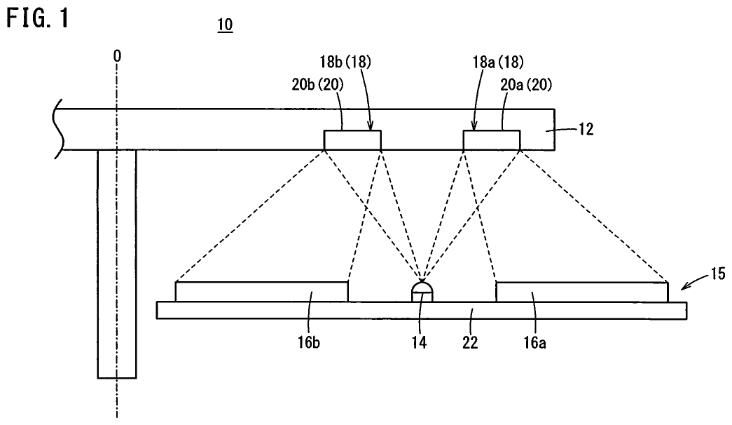

An encoder 10 of the present embodiment is an absolute type rotary encoder capable of detecting an absolute angle. FIG. 1 is a schematic view of the encoder 10. The encoder 10 includes a disk 12 that rotates integrally with a rotor such as a motor, and an optical unit 15 that emits light toward the disk 12 and receives reflected light from the disk 12.

### Disk Configuration

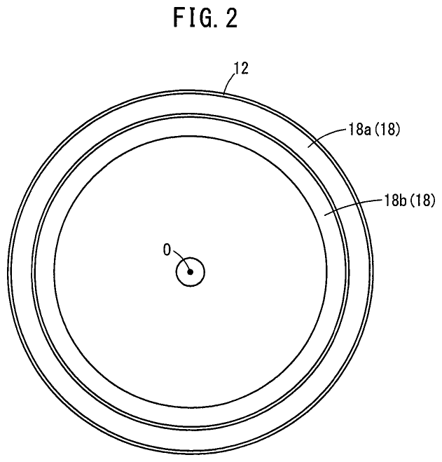

FIG. 2 is a schematic view of the disk 12 as viewed from the rotation axis O direction. The disk 12 is a circular plate having an incremental pattern 18a and an absolute pattern 18b provided on one surface thereof. The incremental pattern 18a and the absolute pattern 18b are provided concentrically around the entire circumference of the disk 12.

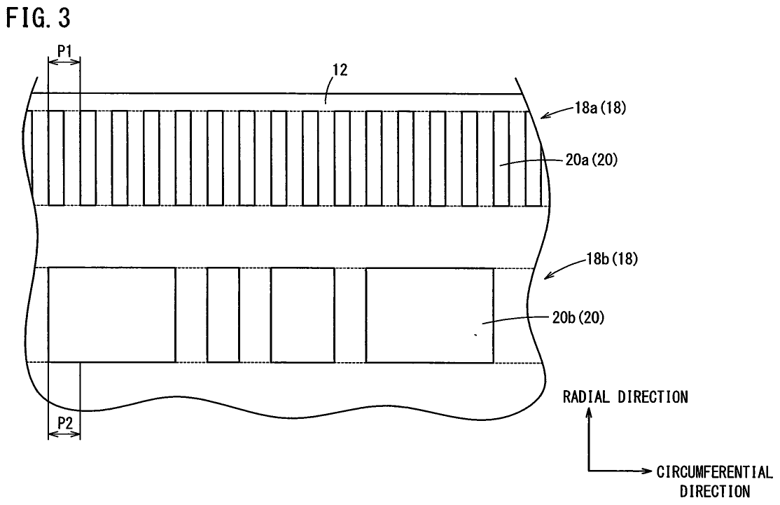

FIG. 3 is an enlarged schematic view of the incremental pattern 18a and the absolute pattern 18b on the disk 12. Although the incremental pattern 18a and the absolute pattern 18b are actually formed in a circular shape, they are schematically illustrated to be linear in FIG. 3. Hereinafter, when the incremental pattern 18a and the absolute pattern 18b do not need to be distinguished from one another, they may be collectively referred to as the pattern 18.

The incremental pattern 18a is composed of a plurality of slits 20a. The absolute pattern 18b is composed of a plurality of slits 20b. Hereinafter, when the slit 20a of the incremental pattern 18a and the slit 20b of the absolute pattern 18b do not need to be distinguished from each other, they may be collectively referred to as the slit 20.

The slit 20 is a reflective slit. The light emitted on the slit 20 on the surface of the disk 12 is reflected by the slit 20, but the light emitted on a place other than the slits 20 is absorbed. The disk 12 is made of, for example, a material that reflects light, such as metal, and the surface of the disk 12 excluding the portion of the slits 20 is coated with a material having a low reflectivity.

The plurality of slits 20a of the incremental pattern 18a are arranged at a predetermined pitch P1 in the circumferential direction of the disk 12. The multiple slits 20b of the absolute pattern 18b are formed to have different widths in an increment of a predetermined pitch P2 (i.e., unit width is the predetermined pitch P2), and are arranged in the circumferential direction of the disk 12. The width and position of each slit 20b of the absolute pattern 18b are so set that the pattern of output signals from the aftermentioned nine light receiving elements 240 to 248 as a result of reception of the reflected light from the slits 20b is uniquely defined by a rotational position of the disk 12 within one revolution.

### Configuration of Optical Unit

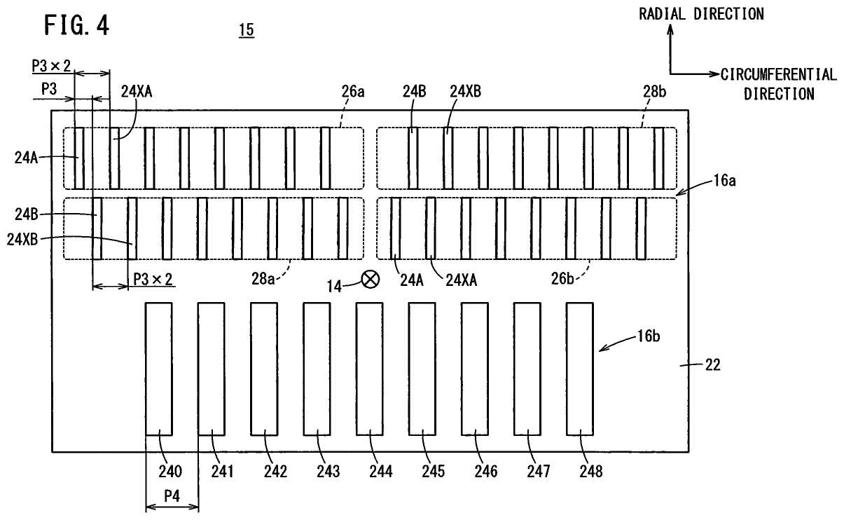

FIG. 4 is a schematic view of the optical unit 15. The optical unit 15 includes a light emitting element 14 for emitting light toward the disk 12, an incremental light receiver 16a for receiving reflected light from the slits 20a of the incremental pattern 18a, and an absolute light receiver 16b for receiving reflected light from the slits 20b of the absolute pattern 18b. The incremental light receiver 16a and the absolute light receiver 16b are provided in arc shapes, but are schematically illustrated in linear shapes in FIG. 4.

The light emitting element 14 is formed of, for example, an LED, and illuminates both the incremental pattern 18a and the absolute pattern 18b on the disk 12. The light emitting element 14 is provided on a substrate 22. The incremental light receiver 16a is disposed radially outward with respect to the light emitting element 14, and the absolute light receiver 16b is disposed radially inward with respect to the light emitting element 14.

The incremental light receiver 16a includes light receiving elements 24A, 24B, 24XA, 24XB provided on the substrate 22, and the four light receiving elements 24A, 24B, 24XA, 24XB form one set of light receiving elements. The incremental light receiver 16a is configured of multiple sets of light receiving elements (eight sets in the present embodiment). The absolute light receiver 16b is composed of multiple (nine in the present embodiment) light receiving elements 240 to 248 provided on the substrate 22. The light receiving elements 24A, 24B, 24XA, 24XB as well as the light receiving elements 240 to 248 are photodiodes, and output signals according to the amount of light received. Hereinafter, when the light receiving elements 24A, 24B, 24XA, 24XB and the light receiving elements 240 to 248 are not particularly distinguished, they may be collectively referred to as the light receiving element 24.

The light receiving elements 24A, 24B, 24XA, 24XB are arranged in a direction in which the slits 20a of the incremental pattern 18a are arranged. The light receiving elements 24A, 24B, 24XA, 24XB are provided on the substrate 22 at a predetermined pitch P3.

The light receiving elements 24A, 24B, 24XA and 24XB output sinusoidal signals as the rotation angle of the disk 12 changes. The light receiving element 24B outputs a signal having a phase delay of π/2 [rad] in electrical angle relative to the signal output from the light receiving element 24A. The light receiving element 24XA outputs a signal having a phase delay of π [rad] in electrical angle relative to the signal output from the light receiving element 24A. The light receiving element 24XB outputs a signal having a phase delay of π [rad] in electrical angle relative to the signal output from the light receiving element 24B.

The light receiving elements 24A and 24XA are arranged in first regions 26a and 26b on the substrate 22, and the light receiving elements 24B and 24XB are arranged in second regions 28a and 28b on the substrate 22. The light receiving elements 24A and 24XA constitute the first light receiving elements of the present invention, and the light receiving elements 24B and 24XB constitute the second light receiving elements of the present invention.

As shown in FIG. 4, the first regions 26a, 26b and the second regions 28a, 28b are provided on the same plane of the substrate 22 so as to be radially separated from each other. The first region 26a and the second region 28a overlap in the circumferential direction, while the first region 26a is located radially outward, and the second region 28a is located radially inward. The first region 26b and the second region 28b overlap in the circumferential direction, while the first region 26b is located radially inward, and the second region 28b is located radially outward. The light emitting element 14 is disposed between the first region 26a and the second region 28b and between the first region 26b and the second region 28a in the circumferential direction.

Thus, the light emitting element 14 can be disposed such that the first region 26a is more distant from the light emitting element 14 than the second region 28a is while the first region 26b is closer to the light emitting element 14 than the second region 28b is. The positional relationship between the light emitting element 14, and the first regions 26a, 26b, and the second regions 28a, 28b, is set such that the difference between the average distance of the optical paths from the light emitting element 14 to the first regions 26a, 26b via the slits 20a of the incremental pattern 18a and the average distance of the optical paths from the light emitting element 14 to the second regions 28a, 28b via the slits 20a of the incremental pattern 18a falls within a predetermined distance.

The light receiving elements 240 to 248 are arranged in a direction in which the slits 20b of the absolute pattern 18b are arranged. The light receiving elements 240 to 248 are provided on the substrate 22 at a predetermined pitch P4.

The light receiving elements 240 to 248 output rectangular wave signals as the rotational angle of the disk 12 changes. The rotational position of the disk 12 within one revolution can be determined based on the combination of the signals output from the light receiving elements 240 to 248.

### Operation and Effect

In order to increase the resolution of the encoder 10, it is necessary to narrow the pitch P1 of the slits 20a of the incremental pattern 18a, and also narrow the pitch P3 of the light receiving elements 24A, 24B, 24XA, 24XB in the incremental light receiver 16a depending on the pitch P1 of the slits 20a.

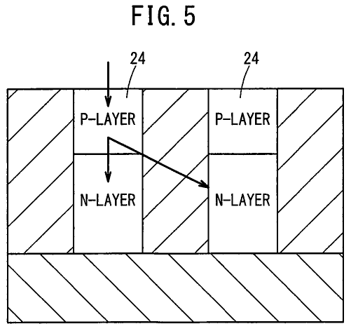

FIG. 5 is a schematic view of the light receiving elements 24. As described above, the light receiving element 24 is a photodiode, which comprises a P-layer and an N-layer. When the light receiving element 24 receives light, holes move to the P-layer and free electrons move to the N-layer. If the pitch between the light receiving elements 24 is too narrow, free electrons may move to the N-layer of the adjacent light receiving elements 24, so that crosstalk may occur in which signals are output from the adjacent light receiving elements 24 that are not receiving light. In order to suppress the crosstalk, it is necessary to secure the pitch of the light receiving elements 24.

For this purpose, in the present embodiment, the first regions 26a, 26b in which the light receiving elements 24A, 24XA are provided and the second regions 28a, 28b in which the light receiving elements 24B, 24XB are provided are separated from each other. Owing thereto, as shown in FIG. 4, the pitch between the light receiving element 24A and the adjacent light receiving element 24XA in the circumferential direction can be set to twice the pitch P3, and the pitch between the light receiving element 24B and the adjacent light receiving element 24XB in the circumferential direction can also be set to twice the pitch P3. As a result, it is possible to enhance the resolution of the encoder 10 and secure the pitch of the adjacent light receiving elements 24 in the circumferential direction, thereby suppressing the occurrence of crosstalk.

Further, in the present embodiment, the first regions 26a, 26b and the second regions 28a, 28b are positioned such that the difference between the average distance of the optical paths from the light emitting element 14 to the first regions 26a, 26b via the slits 20a of the incremental pattern 18a and the average distance of the optical paths from the light emitting element 14 to the second regions 28a, 28b via the slits 20a of the incremental pattern 18a falls within a predetermined distance. As a result, the intensity of light received by the light receiving elements 24A, 24XA in the first regions 26a, 26b can be substantially equal to the intensity of light received by the light receiving elements 24B, 24XB in the second regions 28a, 28b.

### Modification 1

In the first embodiment, the light receiving elements 24A, 24XA are disposed in two areas, i.e., the first region 26a and the first region 26b, and the light receiving elements 24B, 24XB are disposed in two areas, i.e., the second region 28a and the second region 28b. Instead of this, the light receiving elements 24A, 24XA may be put together in one area, i.e., a first region 26, and the light receiving elements 24B, 24XB may be put together in another area, i.e., a second region 28.

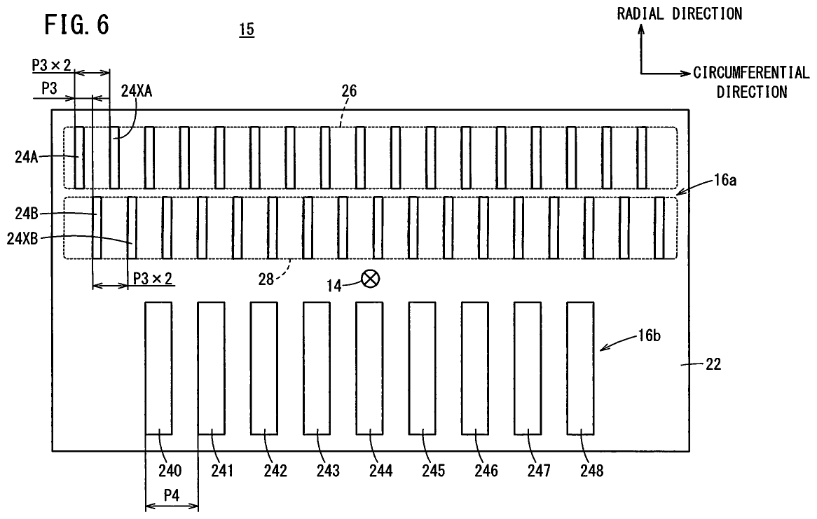

FIG. 6 is a schematic view of an optical unit 15. As shown in FIG. 6, the first region 26 and the second region 28 are provided on the same plane of the substrate 22 so as to be radially separated from each other. The first region 26 is located radially outward, and the second region 28 is located radially inward. Alternatively, the second region 28 may be positioned radially outward, whereas the first region 26 may be positioned radially inward.

### Modification 2

In the first embodiment, the light emitting element 14 is arranged radially inward relative to the first regions 26a, 26b and the second regions 28a, 28b, but may be disposed at another position.

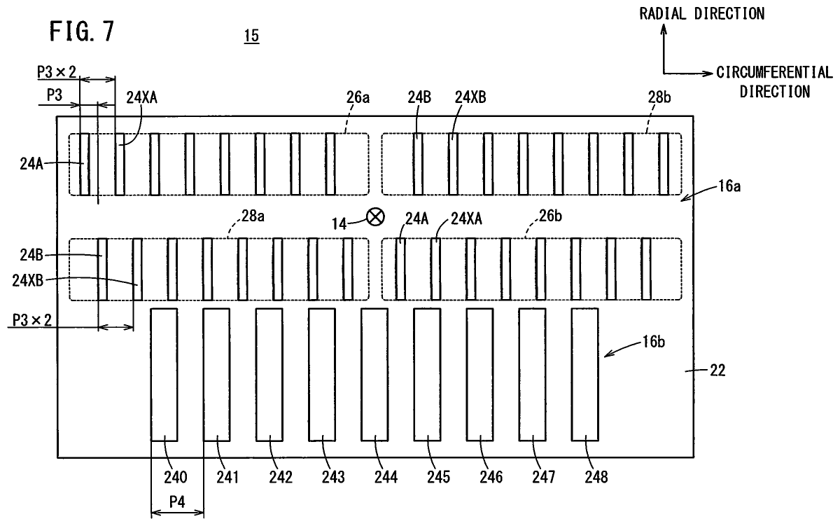

FIG. 7 is a schematic view of an optical unit 15. As shown in FIG. 7, the light emitting element 14 is provided between the first region 26a and the second region 28a, and between the first region 26b and the second region 28b in the radial direction.

### Modification 3

In Modification 1, the light emitting element 14 is arranged radially inward relative to the first region 26 and the second region 28, but may be disposed at another position.

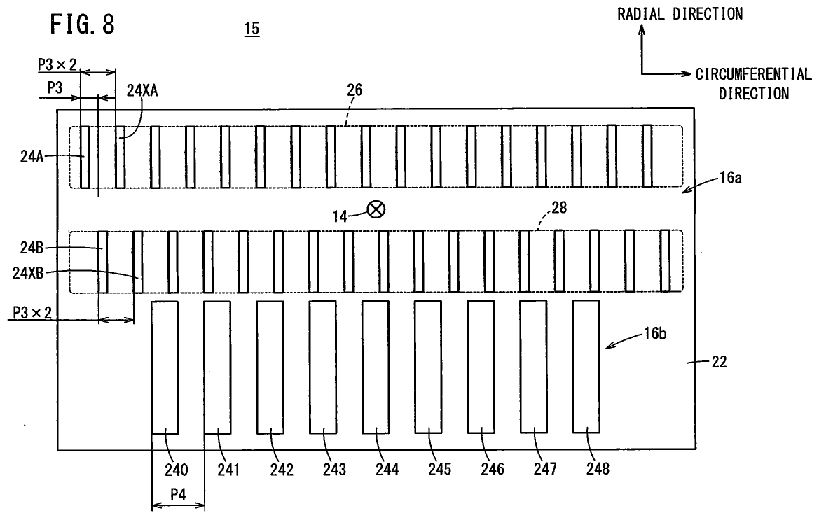

FIG. 8 is a schematic view of an optical unit 15. As shown in FIG. 8, the light emitting element 14 is provided between the first region 26 and the second region 28 in the radial direction.

### Modification 4

In the first embodiment, the first region 26a and the second region 28a are arranged on the same plane and separated from each other in the radial direction while the first region 26b and the second region 28b are arranged on the same plane and separated from each other in the radial direction. The first region 26a and the second region 28a, and the first region 26b and the second region 28b, may be provided separately in a direction intersecting the circumferential direction, not limited to the radial direction.

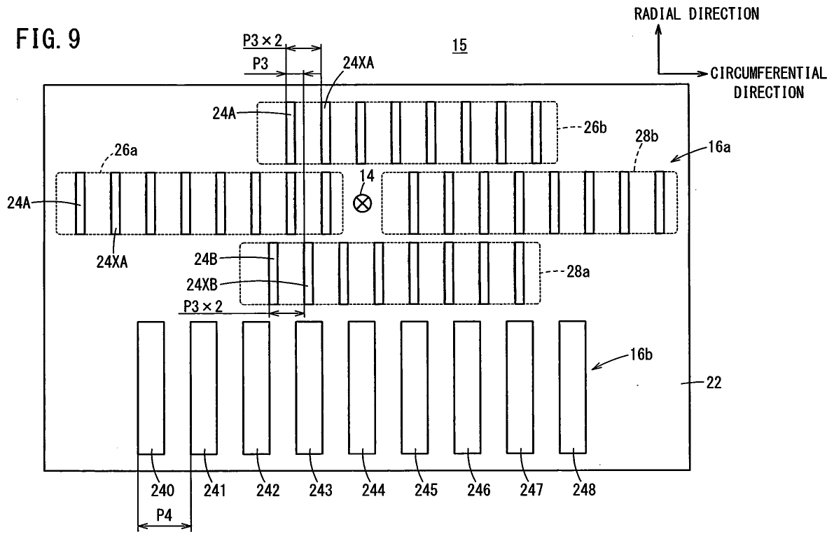

FIG. 9 is a schematic view of an optical unit 15. As shown in FIG. 9, the first region 26a and the second region 28a are provided on the same plane and separated in an oblique direction with respect to the circumferential direction, and the first region 26b and the second region 28b are provided on the same plane and separated in an oblique direction with respect to the circumferential direction. In addition, the light emitting element 14 is disposed at the center surrounded by the first regions 26a, 26b and the second regions 28a, 28b.

### Modification 5

In Modification 1, the first region 26 and the second region 28 are provided so as to be separated from each other in the radial direction, but the first region 26 and the second region 28 may be provided so as to be separated from each other in the circumferential direction.

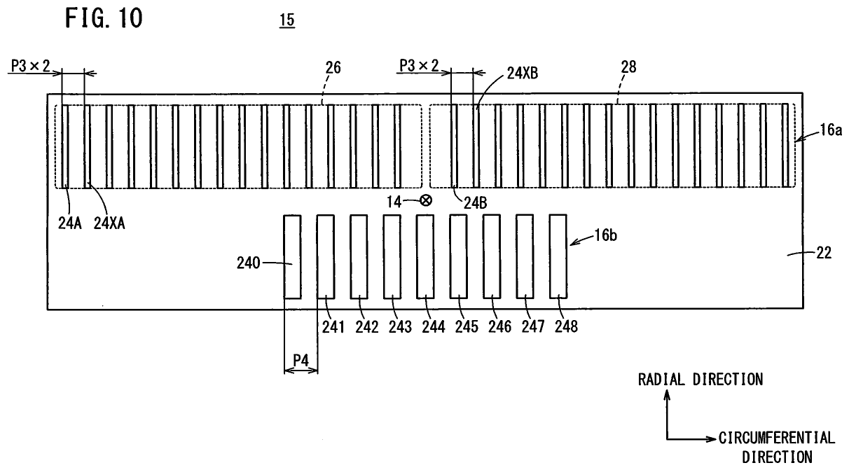

FIG. 10 is a schematic view of an optical unit 15. As shown in FIG. 10, the first region 26 and the second region 28 are circumferentially separated on the same plane of the substrate 22.

### Modification 6

In the first embodiment, the light receiving elements 24A, 24XA are disposed in the first regions 26a, 26b on the substrate 22, and the light receiving elements 24B, 24XB are disposed in the second regions 28a, 28b on the substrate 22. In addition to this, the light receiving elements 240, 242, 244, 246, 248 may be disposed in a third region 30 on the substrate 22, and the light receiving elements 241, 243, 245, 247 may be disposed in a fourth region 32 on the substrate 22.

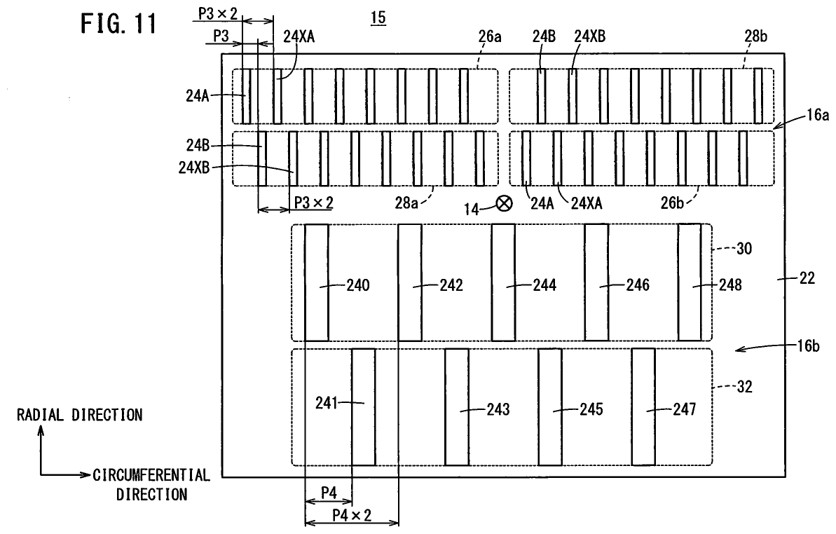

FIG. 11 is a schematic view of an optical unit 15. As shown in FIG. 11, the third region 30 and the fourth region 32 are provided on the same plane of the substrate 22 and separated from each other in the radial direction. Owing thereto, the pitch between adjacent ones of light receiving elements 240 to 248 in the circumferential direction can be set to twice the pitch P4. The light receiving elements 240, 242, 244, 246 and 248 constitute first light receiving elements of the present invention, and the light receiving elements 241, 243, 245 and 247 constitute second light receiving elements of the present invention.

### Modification 7

Though in the first embodiment, a reflective slit is used for the slit 20, a light-transmissive slit that transmits light may be used instead of the reflective slit.

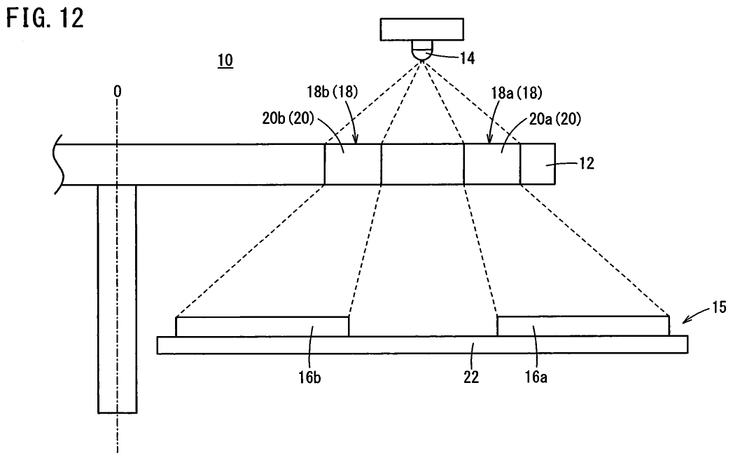

FIG. 12 is a schematic view of the encoder 10. As shown in FIG. 12, when a light-transmissive slit is used for the slit 20, the light emitting element 14 is arranged on the opposite side from the incremental light receiver 16a and the absolute light receiver 16b across the disk 12.

### Modification 8

The encoder 10 of the first embodiment is an absolute type rotary encoder, but the encoder 10 may be an increment type rotary encoder. In the case where the encoder 10 is an increment type rotary encoder, the absolute pattern 18b does not need to be provided on the disk 12, and the absolute light receiver 16b does not need to be provided either.

### Modification 9

Although the encoder 10 of the first embodiment is a rotary encoder, it may be a linear encoder.

### Technical Ideas Obtained From Embodiment

Technical ideas that can be grasped from the above embodiment will be described below.

The encoder (10) includes: a disk (12) configured to have a pattern (18) of slits (20) arranged in one direction; a light emitting element (14) configured to emit light toward the pattern of the disk; a plurality of first light receiving elements (24A) configured to receive the light emitted from the light emitting element, by way of the slits and to output a signal according to the amount of the received light; and a plurality of second light receiving elements (24B) configured to receive the light emitted from the light emitting element, by way of the slits, at a phase different from a phase at which the first light receiving elements receive the light, and to output a signal according to an amount of the received light; wherein a first region (26a) in which the plural first light receiving elements are arranged and a second region (26b) in which the plural second light receiving elements are arranged are provided so as to be separated from each other. With this configuration, it is possible to enhance the resolution of the encoder and secure the pitch of the light receiving elements adjacent in the circumferential direction, thereby suppressing the occurrence of crosstalk.

In the above encoder, the first light receiving elements and the second light receiving elements may be provided on the same plane, and the first region and the second region may be provided so as to be separated from each other in a direction intersecting with the direction in which the slits are arranged. With this configuration, it is possible to enhance the resolution of the encoder and secure the pitch of the light receiving elements adjacent in the circumferential direction, thereby suppressing the occurrence of crosstalk.

In the above encoder, the first light receiving elements and the second light receiving elements may be provided on the same plane, and the first region and the second region may be provided so as to be separated from each other in the direction in which the slits are arranged. With this configuration, it is possible to enhance the resolution of the encoder and secure the pitch of the light receiving elements adjacent in the circumferential direction, thereby suppressing the occurrence of crosstalk.

In the above encoder, the first region and the second region may be arranged so that the difference between the average distance of the optical paths from the light emitting element to the first region via the slits and the average distance of the optical paths from the light emitting element to the second region via the slits falls within a predetermined distance. As a result, it is possible to make the intensity of light received by the light receiving elements in the first region substantially equal to the intensity of light received by the light receiving elements in the second region.

In the above encoder, the first region may include multiple first regions, and the second region may include the same number of second regions as the multiple first regions. As a result, it is possible to make the intensity of light received by the light receiving elements in the first region substantially equal to the intensity of light received by the light receiving elements in the second region.

In the above encoder, the pattern may include at least an incremental pattern (18a). Owing thereto, it is possible to enhance the resolution of the encoder and secure the pitch of the light receiving elements adjacent in the circumferential direction, thereby suppressing the occurrence of crosstalk.

In the above encoder, the pattern may include at least an absolute pattern (18b). Owing thereto, it is possible to enhance the resolution of the encoder and secure the pitch of the light receiving elements adjacent in the circumferential direction, thereby suppressing the occurrence of crosstalk.

In the above encoder, the slits may be reflective slits that reflect the light emitted from the light emitting element. Owing thereto, it is possible to improve the resolution of the encoder by narrowing the pitch of the reflective slits.

In the above encoder, the slits may be light-transmissive slits that transmit the light emitted from the light emitting element. Owing thereto, it is possible to improve the resolution of the encoder by narrowing the pitch of the light-transmissive slits.

While the invention has been particularly shown and described with reference to the preferred embodiments, it will be understood that variations and modifications can be effected thereto by those skilled in the art without departing from the scope of the invention as defined by the appended claims.

What is claimed is:

1. An encoder comprising:
a disk configured to have a pattern of slits arranged in one direction;
a light emitting element configured to emit light toward the pattern of the disk;
a plurality of first light receiving elements configured to receive the light emitted from the light emitting element, by way of the slits and to output a signal according to an amount of the received light; and
a plurality of second light receiving elements configured to receive the light emitted from the light emitting element, by way of the slits, at a phase different from a phase at which the first light receiving elements receive the light, and to output a signal according to an amount of the received light;
wherein a first region in which the plurality of first light receiving elements are arranged and a second region in which the plurality of second light receiving elements are arranged are provided so as to be separated from each other.

2. The encoder according to claim 1, wherein:
the first light receiving elements and the second light receiving elements are provided on a same plane; and
the first region and the second region are provided so as to be separated from each other in a direction intersecting with the direction in which the slits are arranged.

3. The encoder according to claim 1, wherein:
the first light receiving elements and the second light receiving elements are provided on a same plane; and
the first region and the second region are provided so as to be separated from each other in the direction in which the slits are arranged.

4. The encoder according to claim 1, wherein the first region and the second region are arranged so that a difference between an average distance of optical paths from the light emitting element to the first region via the slits and an average distance of optical paths from the light emitting element to the second region via the slits falls within a predetermined distance.

5. The encoder according to claim 1, wherein the first region comprises multiple first regions, and the second region comprises a same number of second regions as the multiple first regions.

6. The encoder according to claim 1, wherein the pattern includes at least an incremental pattern.

7. The encoder according to claim 1, wherein the pattern includes at least an absolute pattern.

8. The encoder according to claim 1, wherein the slits are reflective slits that reflect the light emitted from the light emitting element.

9. The encoder according to claim 1, wherein the slits are light-transmissive slits that transmit the light emitted from the light emitting element.
